(19) United States
(12) Patent Application Publication
(10) Pub. No.: US 2024/0020628 A1
(43) Pub. Date: Jan. 18, 2024

(54) INVENTORY MANAGEMENT FOR A NETWORK TRAFFIC SURGE RESISTANT PLATFORM

(71) Applicant: Fevo, Inc., New York, NY (US)

(72) Inventors: Vladimir Mitevski, New York, NY (US); Ari Daie, New York, NY (US)

(21) Appl. No.: 17/865,933

(22) Filed: Jul. 15, 2022

(51) Int. Cl. G06Q 10/08; G06Q 30/06

(52) U.S. Cl. CPC G06Q 10/087; G06Q 30/0641

(57) ABSTRACT

A system and method to manage a surge network traffic targeting a service-hosting platform are disclosed. For an offer of goods and/or services, the platform provider generates a static package that is placed in networked storage that is accessible through a web service interface. The package contains the information required to instantiate and render the interface of the service-hosting platform using the processor and resources of the computer that accesses the package via a browser. Based on the contents of the package, the rendered interface presents the services of the service-hosting platform using resources of the customer's computer without making any calls to a server to query a protected backend system. The inventory may be refreshed from time-to-time without causing traffic directed at the service-hosting platform. Access to the protected backend resources and platform resources is gated by threshold actions taken by the user.

### RELATED APPLICATIONS

This application is related to U.S. patent application Ser. No. ______ entitled “NETWORK TRAFFIC SURGE RESISTANT PLATFORM,” filed on the same day (Attorney Docket No. 48987-00102), U.S. patent application Ser. No. ______ entitled “A DYNAMIC USER INTERFACE FOR A NETWORK TRAFFIC SURGE RESISTANT PLATFORM,” filed on the same day (Attorney Docket No. 48987-00103), U.S. patent application Ser. No. ______ entitled “INVENTORY MANAGEMENT SYSTEM PROTECTION FOR NETWORK TRAFFIC SURGE RESISTANT PLATFORM,” filed on the same day (Attorney Docket No. 48987-00105), and U.S. patent application Ser. No. ______ entitled “AUTHENTICATION MANAGEMENT FOR A NETWORK TRAFFIC SURGE RESISTANT PLATFORM,” filed on the same day (Attorney Docket No. 48987-00106), each of which is herein incorporated by reference in their entirety.

### TECHNICAL FIELD

The present invention is generally related to webhosting of electronic commerce and, more specifically, management of surge network traffic to an electronic commerce platform.

### BACKGROUND

Purchasing high demand goods and/or services, such as popular toys or event tickets, can be frustrating for consumers and potentially debilitating for electronic commerce platform providers. Increasingly, merchants use flash sales or other such events where all or part of the available inventory is, for a limited amount of time, offered to a group of people at a special price and/or is offered as an opportunity to purchase before the general public. Merchants may use such events to offer benefits to a particular group of customers (e.g., premium members, students, faculty, etc.), as a form of price differentiation, and/or to capture the attention of highly motivated customers, etc. Sometimes, instead of a preplanned event, consumer interest in a good or service is so high that a similar surge in traffic is generated upon an initial offer of the good or service. In such scenarios, instead of managing infrastructure (e.g., servers, databases, network bandwidth, etc.) for mean site traffic, the merchant's site must be configured to handle relatively infrequent surges of high network traffic volume that include a large number of requests into the merchant's backend infrastructure. For example, a flash sale can act like a denial of service attack, but where the traffic is legitimate. Often, backend systems, such as inventory management systems, are built with older technology that cannot handle the massive volume of queries into its databases. Such backend systems can be overwhelmed by these high traffic value events.

### SUMMARY

Systems and methods for providing an electronic commerce platform that manages surges of high network traffic volume while protecting backend computing resources are described herein. For an offer of goods and/or services, the platform provider generates a static package that is placed in networked storage (e.g., networked object storage, etc.) that is accessible through a web service interface. The package contains the information required to instantiate and render the interface of the store, as well as information that is necessary to complete a transaction. When the offer is electronically communicated via a link, the linked location on the merchant platform's server includes just enough HTML instructions to retrieve the package from the storage and instantiate the interface. Based on the contents of the package, the interface of the merchant platform is then rendered in the browser of the customer using the processor and resources of the customer's computer (e.g., not resources a server of the merchant platform). During this process, the graphical elements of the interface may be retrieved from the networked storage. Based on the contents of the package, the rendered interface presents available inventory and performs cart management (e.g., presenting available inventory, selecting/deselecting goods and/or services to be placed in the cart, etc.) using resources of the customer's computer without making any calls to a server to query an inventory management system. The interface only performs backend calls (e.g., calls to the merchant platform server, etc.) when necessary to complete the next stage of the transaction (e.g., after the customer takes an affirmative step in the transaction). For example, when the customer clicks on an action button that signals that they desire to proceed with checking out, a call to an inventory server to query the relevant inventory management system(s) is made to place a temporary hold on the desired inventory. The rendered interface collects information to authenticate the identity of the customer and collects payment information. The interface then performs backend calls to the relevant system (e.g., the payments system, the customer management system, etc.) to verify the customer's information and process the payment. After, the payment is processed and the customer is identified, the merchant platform makes a call to the inventory management system to reserve the goods and/or services for the customer.

The available inventory for the browser by the cart interface is included in the offer package. When the user's computing device instantiates the cart interface based on the offer package, the cart interface includes the available inventory. Inventory updates are not provided directly by the commerce platform to the computing device. Rather, from time-to-time, the commerce platforms updated the available inventory and republished the offer package with the updated inventory. When the browser operating on the computing device refreshes, the offer instantiator causes the browser to retrieve the offer package with the updated inventory and re-instantiate the cart interface with the updated inventory. Additionally, to reduce processing resources and time required by the computing devices to instantiate the cart interface with the available inventory, the commerce platform performs preprocessing on the available inventory. The commerce platform performs filtering on the available inventory, based on the attributes of the available inventory, to device the available inventory into inventory slices. By organizing and slicing inventory and placing the pre-processed inventory into the offer package, the commerce platform, for example, (i) reduces the processing required to instantiate the cart interface by the browsers of the user to accommodate relatively frequent updates to the offer package, and (ii) provides organization to facilitate the user interacting with as few interactive elements as possible to select the goods and/or services to be purchased, which is important when considering the limited space available to provide the cart interface on the screen of a mobile device.

An example network traffic surge resistant system includes network storage and one or more servers configured as a commerce platform. At a first time, the commerce platform generates a script, a first offer package, and an offer instantiator, and stores the script and the first offer package onto the network storage. The offer instantiator provides the location of the script and the first offer package in the network storage. The first offer package including a first set of inventory slices. At a second time after the first time, the commerce platform generates a second set of inventory slices and generates a second offer package that includes the second set of inventory slices and replace the first offer package with the second offer package in the same location in the network storage. Generating second set of inventory slices does not cause the commerce platform to generate an update signal to any browsers. In response to a browser operating on a computing device accessing the offer instantiator after the first time but before the second time: (i) the offer instantiator causes the browser to retrieve the script and the first offer package from the network storage, and (ii) the script causes the browser to instantiate a cart interface within the browser based on the first offer package using the resources of the computing device without making a backend call to the commerce platform. The cart interface includes a first set of inventory items based on the first set of inventory slices. In response to the browser accessing the offer instantiator after the second time: (i) the offer instantiator causes the browser to retrieve the second offer package from the network storage, and (ii) the script causes the browser to instantiate the cart interface within the browser based on the second offer package using the resources of the computing device without making a backend call to the commerce platform. The cart interface includes a second set of inventory items based on the second set of inventory slices.

A example method for asynchronously updating a cart interface for a network traffic surge resistant platform, includes, at a first time, (i) generating, by the network traffic surge resistant platform, a script, a first offer package, and an offer instantiator, and (ii) storing the script and the first offer package onto the network storage. The offer instantiator provides the location of the script and the first offer package in the network storage. The first offer package includes a first set of inventory slices. The method also includes, at a second time after the first time, (i) generating, by network traffic surge resistant platform, a second set of inventory slices, wherein generating second set of inventory slices does not cause the commerce platform to generate an update signal to any browsers, and (ii) generating a second offer package that includes the second set of inventory slices and replace the first offer package with the second offer package in the same location in the network storage. The method includes, in response to a browser operating on a computing device accessing the offer instantiator after the first time but before the second time: (i) causing, by the offer instantiator, the browser to retrieve the script and the first offer package from the network storage, and (ii) causing, by the script, the browser to instantiate a cart interface within the browser based on the first offer package using the resources of the computing device without making a backend call to the commerce platform, The cart interface includes a first set of inventory items based on the first set of inventory slices.

In response to the browser accessing the offer instantiator after the second time: (i) causing, by the offer instantiator, the browser to retrieve the second offer package from the network storage, and (ii) causing, by the script, the browser to instantiate the cart interface within the browser based on the second offer package using the resources of the computing device without making a backend call to the commerce platform. The cart interface including a second set of inventory items based on the second set of inventory slices.

### BRIEF DESCRIPTION OF THE DRAWINGS

Operation of the present disclosure may be better understood by reference to the following detailed description taken in connection with the following illustrations, wherein:

FIG. 1 is a block diagram of an example system to provide an electronic commerce platform to manage a surge network traffic, according to the teachings of this disclosure.

FIG. 2 is a conceptual diagram of bricks used to construct a package used to manage the surge network traffic, according to the teachings of this disclosure.

FIG. 3 is a conceptual diagram of the packager of FIG. 1 generating an offer package, according to the teachings of this disclosure.

FIG. 4 is a conceptual diagram of the commerce platform of FIG. 1 publishing the offer package, according to the teachings of this disclosure.

FIGS. 5A and 5B illustrate example cart interfaces, according to the teachings of this disclosure.

FIG. 6 illustrates an example cart interface with a hierarchical organization, according to the teachings of this disclosure.

FIG. 7 illustrates an example method to update inventory in a cart interface without the cart interface making backend calls, according to the teachings of this disclosure.

FIGS. 8A and 8B illustrate an example method to provide for a network traffic surge resistant platform, according to the teachings of this disclosure.

### DETAILED DESCRIPTION

Reference will now be made in detail to exemplary embodiments of the present disclosure, examples of which are illustrated in the accompanying drawings. It is to be understood that other embodiments may be utilized, and structural and functional changes may be made without departing from the respective scope of the present disclosure. Moreover, features of the various embodiments may be combined or altered without departing from the scope of the present disclosure. As such, the following description is presented by way of illustration only and should not limit in any way the various alternatives and modifications that may be made to the illustrated embodiments and still be within the spirit and scope of the present disclosure.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggests otherwise.

Commerce platforms that offer high demand and/or limited time offers for good and/or services often require backend systems (e.g., physical and/or virtual servers, databases, network bandwidth, etc.) that are deployed to meet or scale to surges in network traffic as a large number of customers simultaneously attempt to procure the goods and/or services. For example, platforms that handle ticket sales for major events (e.g., sports, concerts, etc.) often see such surges in network traffic as tickets are released. These surges can be orders of magnitude greater than the mean or ordinary network traffic and can overwhelm the commerce platform and its surrounding infrastructure with the flood of Internet traffic. Managing these sources can be costly and error prone, as it depends on recognizing the surge and differentiating the surge from illegitimate traffic (e.g., a denial of service attack, etc.). Additionally, in many cases, some backend systems, such as inventory management systems, are deployed using technology that is hard to scale (if even possible) and cannot handle the volume of requests necessary to service the traffic. For examples, generally scalability must be part of the design of a database and many inventory systems were deployed before scalability was required. This can lead to slowing, instability and/or termination of the operation of the ecommerce platform because the network and the backend system cannot cope or adapt quickly to the surge. Attempted techniques, such as queues and timed inventory reservation systems, etc., are often not effective in mitigating the effects of surge the network traffic and can be used by malicious actors and/or undesirable consumers to deny some or all customers access to purchasing the good and/or services on the commerce platform. Accordingly, there are technical problems that prevent a commerce platform from being able to manage surges in network traffic volume without negatively affecting the backend systems that comprise the commerce platform.

As described herein, network traffic volume can inundate the platform. Without techniques to mitigate this surge of traffic, the platform may be degraded in its technical ability to operate and its servers may become overwhelmed. That is, the traffic surge may deny access to network resources, such as the servers running platform. Managing inventory in the face of a surge of network traffic to a platform can be difficult. A secondary effect of a surge in legitimate traffic to the platform is an increase use of resources to manage the inventory. This is especially true when the underlying inventory management system (IMS) is implemented in older technology that was not designed for a massive number of near simultaneous queries. This flood of network traffic can cause the database of the IMS to become unresponsive. Additionally, when inventory is being access frequently, updating inventory status to users still browsing can create an additionally layer of network traffic. Some of this increased traffic is ultimately unnecessary if the user never becomes a customer. Accordingly, there is a need to a method to maintain current information in cart interfaces while not generate more traffic directed at the commerce platform.

The term “server” has its ordinary meaning. Generally, a server provides computational services in a request—response model where, in response to a request (sometime referred to as a “call”) over a network, the server performs some computational action and sends a response back to the requesting computer. As used herein, a “backend call” refers a request by an interface operating on the computing device of a customer to a non-static network resource (e.g., a server, a database, etc.). A “backend call” generally requires the server(s) of the commerce platform to process the request and generate information to be sent to the requester that is responsive to the contents of the request. For example, the backend call may require a query into an inventory database to determine status of inventory associated with the offer. Though the intensity can vary, backend calls are relatively computationally intensive to network resources. The terms “network storage” and “cloud storage” have their ordinary meaning. Generally, network storage provides object storage through a web service interface to facilitate remote storage and retrieval of data objects. As used herein, a “static call” refers to a request to a static network resource, such as networked storage that stores data objects (e.g., visual elements for an interface, scripts to be executed by the interface, offer packages, etc.). Static calls are relatively computationally inexpensive. As used herein, an “offer instantiator” refers to a document designed to be processed in a web browser that includes (i) structure (e.g., written in HTML code, etc.) necessary to render a cart interface, (ii) a location of where to receive a related offer package (e.g., from networked storage), and (iii) a location to receive a script to render the cart interface using the structure and the offer package.

A merchant that desires to make an offer via a surge traffic resistant commerce platform (“commerce platform”) generates an offer package through the commerce platform. The offer package contains information necessary to render a cart interface and browse inventory associated with the offer without making backend calls to the commerce platform or any inventory management system tracking the inventory associated with the offer. The package may be, for example, generated in a data-interchange format. The package is then stored on one or more static network storage devices. To communicate the offer, the commerce platform creates a link (e.g., a Uniform Resource Locator (URL), etc.) that points to an address that contains the location of the offer package, the location of the script to render the cart interface, and a minimum amount of code (e.g., HTML, etc.) necessary to use the script to render the cart interface.

When a consumer activates the link, the consumer's browser fetches the offer package and the script to render the cart interface (e.g., by generating browser readable code, etc.) on the commuting device executing the browser. That is, instead of a server (e.g., one of the servers of the commerce platform) generating the cart interface and then sending the browser readable code defining the cart interface to the browser, the computing device of the customer generated the browser readable code for the cart interface using the script and based on the offer package. In such as manner, when a surge of customers are simultaneously or near simultaneously interacting with the cart interface, a corresponding serge of traffic is not generated directed at the servers of the commerce platform and those servers are not overwhelmed by the resulting processing to generate and update the cart interface. The cart interface includes an action button. The browser generated cart interface performs pre-checkout cart management functions using the resources of the browser without making inventory or checkout related backend calls to the servers of the commerce platform until the action button is activated (e.g., “clicked on”) by the customer. These pre-checkout cart management functions include browsing inventory (e.g., names, descriptions, and/or prices of inventory available through the offer, etc.), receiving an indication of the type and/or quantity that the customer desires to purchase, and/or calculating an estimated total cost of the indicated type and quantity. Because the package includes all of the inventory information (e.g., offer details, identities and descriptions of inventory available with the offer, price, etc.), the cart interface performs these pre-checkout functions without making any backend calls. Thus, a surge of customers browsing inventory, many of whom are not likely to complete a purchase, does not create a corresponding surge in network traffic or server load for the commerce platform. From time-to-time, the commerce platform may asynchronously regenerate the offer package to change any part of the offer, including available inventory, the theme or template, etc., to replace the previous package at the same location in the static network storage. Thus, the merchant may dynamically update the cart interface without causes a surge of network traffic or server load.

When the customer activates the action button, the browser renders, based on the offer package, a checkout interface and makes a backend call that includes the identities and quantities of the inventory in the current cart of the cart interface. This backend call causes one of the servers to calculate the actual (e.g., non-estimated) cost, including the unit cost of each item and any associated fees, to the items in the cart and report that total to the checkout interface. The customer may change quantities (e.g., add quantities, subtract quantities, delete items, etc.) in the checkout interface. Each changes results in the backend call to calculate the total cost of the items. These price calculations are performed without querying the inventory management system of the merchant. Thus, a large number of such backend calls does not result in an increased load on the merchant's inventory management system. In some examples, these backend calls are configured to be computationally light to reduce any strain on the servers of the commerce platform.

When the browser receives the calculation, the checkout interface displays the total. The checkout interface performs a redirect to a payment processor. In some examples, this causes the payment processor to instantiate one or more payment electronic widgets (e.g., a Google® Pay widget, an Apple® Pay widget, etc.) and/or a credit card payment widget in the checkout interface. Interacting with one of the electronic payment widgets or the credit card payment widget (e.g., providing payment credentials, etc.) causes the payment processor to generate a payment intent that places a hold on funds equal to the calculated amount. Up to this point, the merchant platform does not make any call to the inventory management system of the merchant. After the payment processor signals that the payment intent was successful, the commerce platform attempts to place a reserve on the items with the inventory management system of the merchant. When the inventory management system signals that the attempt to reserve the inventory was successful, the commerce platform initiates one or more authenticity/security checks (sometimes referred to as “authorization challenges”) with the customer via the checkout interface. When all of the authenticity/security checks are successful, the commerce platform requests that the inventory management system place the reserved items be in a fulfillment status. The commerce platform then signals the payment processor to complete the transaction based on the purchase intent. The commerce platform then performs post-purchase fulfillment actions via the checkout interface. In such a manner, the commerce platform minimizes network traffic, server load, and load on the inventory management system by only generating such activity when the customer has affirmatively signaled their desire to complete a transaction and only to the extent necessary for their current level of commitment.

As described here, the available inventory for the browser by the cart interface is included in the offer package. When the user's computing device instantiates the cart interface based on the offer package, the cart interface includes the available inventory. Inventory updates are not provided directly by the commerce platform to the computing device. Rather, from time-to-time, the commerce platforms updated the available inventory and republished the offer package with the updated inventory. When the browser operating on the computing device refreshes, the offer instantiator causes the browser to retrieve the offer package with the updated inventory and re-instantiate the cart interface with the updated inventory. To network traffic, the commerce platform does not send a signal to or otherwise inform the computing device in response to regenerating and republishing the offer package. The browser may refresh when (i) the user manually refreshes it, (ii) the cart interface automatically refreshes at a configurable interval (e.g. every 30 seconds, every 60 seconds, etc.), and/or (iii) when the commerce platform signals that there is a mismatch between the currently available inventory as tracked by the commerce platform and the selections made by the user (e.g., in response to the user hitting the action button of the cart interface, etc.).

Additionally, to reduce processing resources and time required by the computing devices to instantiate the cart interface with the available inventory (e.g., after retrieving an updated offer package, etc.) (e.g., to reduce the time it takes from downloading the updated offer package to the updates being available to the user), the commerce platform performs preprocessing on the available inventory. The commerce platform performs filtering on the available inventory, based on the attributes of the available inventory, to the device of the available inventory into inventory slices (sometimes referred to as “variants”). This process is sometimes referred to herein as “slicing the inventory.” Inventory slices represent categories of inventory items that may be combined to be presented to the user in the cart interface, with each inventory item in the inventory slice being fungible (e.g., a good or asset that is interchangeable with other individual goods or assets of the same type) or pseudo-fungible (e.g., a good or asset that is interchangeable with other individual goods or assets of a similar type, where the non-fungible attributes are ignored for the purposes of interchangeability). For example, supporter scarves of the same design may be fungible or hoodie of the same color, style, and size may be fungible. As another examples, tickets for the occupation of specific seats in a venue (a non-fungible item) may be considered pseudo-fungible with other seats in the same row and section or in the same section of the venue, as configurable by the commerce platform and/or the merchant. As another example of a pseudo-fungible item that may be sliced, a set of autographed cards may be limited edition and numbered, but the commerce platform may treat them as fungible items (e.g., the user does not have an opportunity to a select a particular autographed card).

As described herein, the slices of inventory may be sliced further to create a hierarchy of inventory slices. For example, if the inventory table has inventory items with attributes A, B, C, and D, a first level inventory slice may be defined to be the inventory with attributes A, C, and D and the second level inventory slice may be defined to be the inventory within the first level slice with the attribute D. The lowest level in the hierarchy (sometimes referred to as the “bottom slice”) is associated with a quantitative selection element (sometimes referred to as a “quantity picker”) and is presented in the cart interface instantiated by the browser as a selectable item of inventory. In some examples, the bottom slices of inventory in the hierarchy are comprised of non-fungible items or other items of limited availability (e.g., a limited edition, numbered autograph, a non-funigible token, etc.). By organizing and slicing inventory and placing the pre-processed inventory into the offer package, the commerce platform, for example, (i) reduces the processing required to instantiate the cart interface by the browsers of the user to accommodate relatively frequent updates to the offer package, and (ii) provides organization to facilitate the user interacting with as few interactive elements as possible to select the goods and/or services to be purchased, which is important when considering the limited space available to provide the cart interface on the screen of a mobile device.

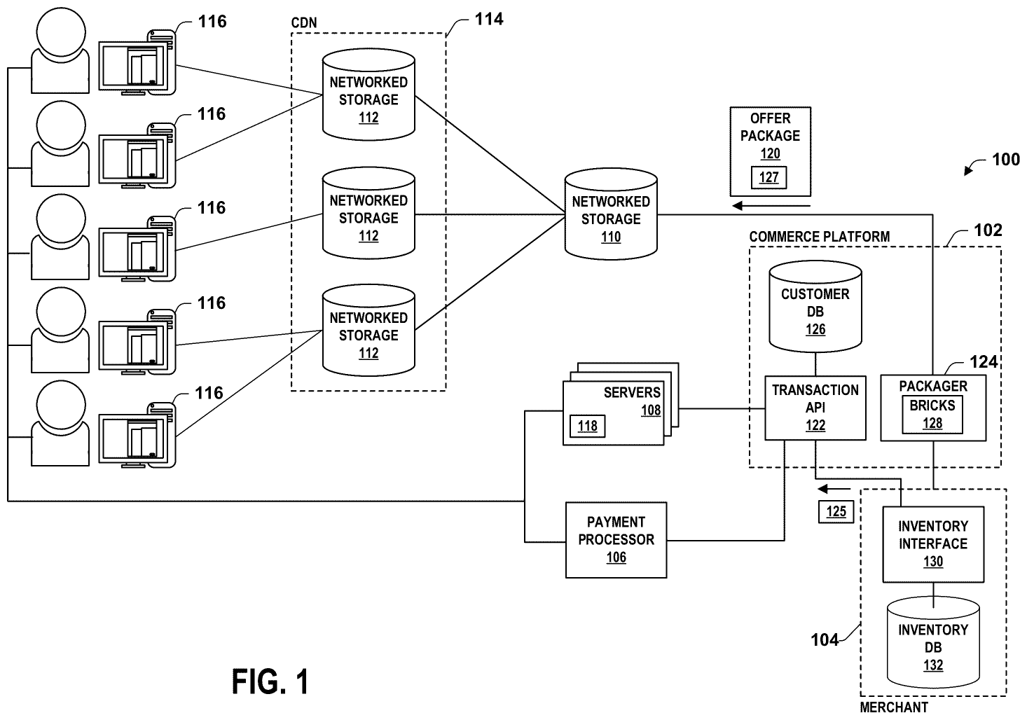

FIG. 1 is a block diagram of an example system 100 to provide an electronic commerce platform 102 to manage a surge network traffic. In the illustrated example, the commerce platform 102 is communicatively coupled merchant networks (e.g., merchant network 104) and payment processors 106. The commerce platform 102 is also communicatively coupled to one or more webservers 108 (e.g., physical servers, virtual servers, and/or virtualized containers, etc.) and one or more network storage devices 110 (e.g., Amazon® S3, Google® Cloud Storage, Azure® Blob Storage, IBM® Cloud Object Storage, etc.). Data objects stored in the network storage devices 110 may be pushed onto network storage devices 112 that part of a content delivery network (CDN) 114 to be accessed by browsers operating on computing devices 116 (e.g., desktop computers, laptop computers, smart phones, tablets, smart televisions, etc.). The commerce platform 102 facilitates generation of offer instantiators 118 and offer packages 120 by a merchant to offer goods and/or services of managed by the merchant network 104 though the commerce platform 102.

The commerce platform 102 includes a transaction application programming interface (API) 122, a packager 124, and a customer database 126. While in the illustrated example, the transaction API 122, the packager 124, the customer database 126, and the webservers 108 are illustrated as being conceptually grouped in a certain configuration for simplicity, these components may be otherwise situated in any suitable manner (e.g., on cloud servers, etc.). The transaction API 122 facilitates communication between the webservers 108, the payment processor 106, the merchant network 104, and the customer database 126. The packager 124 receives input from the merchant to generate the offer instantiator 118 and the offer package 120 using software bricks 128. In some examples, the package 124 generates the offer package 120 in a data-interchange format (e.g., JavaScript Object Notation (JSON), Extensible Markup Language (XML), YAML, etc.). The software brick 128 are offer package components that define the parameters, metadata, available inventory and/or audiovisual assets of the offer and the interrelationship between these parameters, metadata, available inventory and/or audiovisual assets. The customer database 126 stores customer information to facilitate assigning an order from a checkout interface in a browser to a particular account or accounts for security and fulfillment purposes. The structure and organization of the offer package 120 are dictated by which bricks are used to generate the offer package 120.

Using the packager 124, the merchant defines the offer and provides an inventory data object 125 that specifies the available inventory for the offer and attributes of the inventory the merchant uses to distinguish the inventory. In some examples, the inventory data object 125 comprises a two dimensional table with a row for every good or service to be offered or class of goods or services to be offered (e.g., for non-fungible items) with one or more attributes related to the goods or services. For example, the data object may include a row for each seat in a venue that is to be part of the offer, and a column for the section number, a column for the row number, a column for the seat number, and a column for a classification of the seat (e.g., student seating, VIP seating, etc.). From time-to-time (periodically or aperiodically), the merchant may provide an updated inventory data object 125. For example, the packager 124 may request, at an interval no shorter than a refresh interval specified by the inventory management system of the merchant 104 (e.g., where the refresh interval is set to protect the integrity and operation of the IMS), an update to the inventory data object 125. The packager 124 generates a unique link (e.g., a URL link, etc.) that instructs a browser where to locate the offer instantiator 118. The offer package 120 contains the information necessary for the offer instantiator 118, when accessed by a browser, to render the cart interface and the checkout interface, including a description of the available inventory to facilitate a customer browsing the inventory through the cart interface without making any backend calls to the webservers 108 and/or the transaction API 122. As part of generating the offer package 120, the packager 124 pre-processes the inventory data object 125. The packager 124 slices the inventory data object 125 into inventory slices 127. The inventory slices 127 are, as explained below, packaged into the offer package 120. After the offer instantiator 118 and offer package 120 are created, the packager 124 publishes the instantiator 118 onto the webservers 108 and pushed the offer package 118 onto the networked storage 110 and 112. The link to the instantiator 118 may then be provided to customers. In the illustrated example, the instantiator 118 is located on a server and is accessible via a domain that is controlled/operated by the commerce platform 102. Alternatively, in some examples, the instantiator 118 maybe located on a server and accessible via a domain that is controlled/operated by another party (e.g., the merchant network 104, a third party, etc.).

The offer package 120 may be regenerated from time-to-time with new and/or updated parameters, metadata, available inventory and/or audiovisual assets of the offer. For example, the offer packager 124 may regenerate the offer package 120 periodically, in response to a change in the parameters and/or metadata associated with any bricks 128 used to generate the offer package 128, and/or in response to receiving or otherwise retrieving an updated inventory data object 125. When the offer package 120 is rebuilt, the packager 124 pushes the updated offer package to replace the old offer package in the networked storage 110 and 112. In such a manner, the merchant can dynamically and asynchronously update the offer package 130 while customers access the offer instantiator 118 without interruption.

The example merchant network 104 includes an inventory interface 130 and an inventory database 132 (collectively may be referred to as an “inventory management system” or “IMS”). The inventory from which the inventory data object 125 is compiled is stored in the inventory database 132. The inventory interface 130, using the inventory database 132, provides the inventory data object 125. The inventory interface 130 may also manipulate the inventory in the inventory database 132 by, for example, changing the status of the inventory (e.g., reserving the inventory, marking the inventory for fulfillment, etc.). In some examples, because too frequent compilations of inventory may cause the degradation or loss of operation of the IMS (e.g., the inventory database 132) and/or may interfere with ability of the IMS to change the status of the inventory as purchases are made, the inventory interface 130 may set a refresh interval limit the frequency at which the packager 124 may request a refresh of the inventory data object 125.

When a consumer activates the link to the offer instantiator 118, the consumer's browser performs a static call to retrieve the offer package 120 and the script to render the cart interface (e.g., by generating browser readable code, etc.) from the network storage 110 and 112. The browser then renders the cart interface by executing the script using the offer package 120, including populating the available inventory in the cart interface based on the inventory slices 127. This available inventory does not change through direct updates or making a backend call for the update. The browser generated cart interface performs pre-checkout cart management functions using the resources of the browser. These pre-checkout cart management functions include browsing inventory (e.g., names, descriptions, and/or prices of inventory available through the offer, etc.) as defined by the inventory data object (e.g., as processed by the bricks 128).

From time-to-time, the browser may refresh access to the offer instantiator 118. For example, the user may refresh the browser or the browser may receive a signal to refresh access to the offer instantiator in response to making a backend call. Then the browser refreshes access to the offer instantiator 118, the browser performs a static call to retrieve the offer package 120 and the script to render the cart interface from the network storage 110 and 112. If the offer package 120 has been updated since the last time the offer package 120 was retrieved, the offer instantiator will cause the browser to retrieve the updated offer package 120. The browser then renders the cart interface by executing the script using the updated offer package 120, including any updated inventory slices 127.

When the customer activates the action button, the browser renders, based on the offer package 120, a checkout interface and makes a backend call that includes the identifiers (sometimes referred to as “inventory unit identifiers) that identify inventory in the current cart of the cart interface and quantities of the inventory in the current cart of the cart interface. This backend call causes one of the servers 108 to calculate the actual (e.g., non-estimated) cost, including the unit cost of each item and any associated fees, to the items in the cart and report that total to the checkout interface. The customer may change quantities (e.g., add quantities, subtract quantities, delete items, etc.) in the checkout interface. Each changes results in the backend call to the servers 108 to calculate the total cost of the items.

When the browser receives the calculation, the checkout interface displays the total. The checkout interface performs a redirect to the payment processor 106. In some examples, this causes the payment processor 106 to instantiate one or more payment electronic widgets (e.g., a Google® Pay widget, an Apple® Pay widget, etc.) and/or a credit card payment widget in the checkout interface. Successfully credentialing through one of the electronic payment widgets or the credit card payment widget causes the payment processor 106 to generate a payment intent that places a hold on funds equal to the calculated amount. After the payment processor 106 signals that the payment intent was successful, the transaction API 122 attempts to place a reserve on the items with the inventory management system. When the inventory management system signals that the attempt to reserve the inventory was successful, the transaction API 122 initiates one or more authenticity/security checks with the customer via the checkout interface. When all of the authenticity/security checks are successful, the transaction API 122 requests that the inventory management system place the reserved items in a fulfillment status. The transaction API 122 then signals the payment processor 106 to complete the transaction based on the purchase intent. The transaction API 122 then performs post-purchase fulfillment actions via the checkout interface.

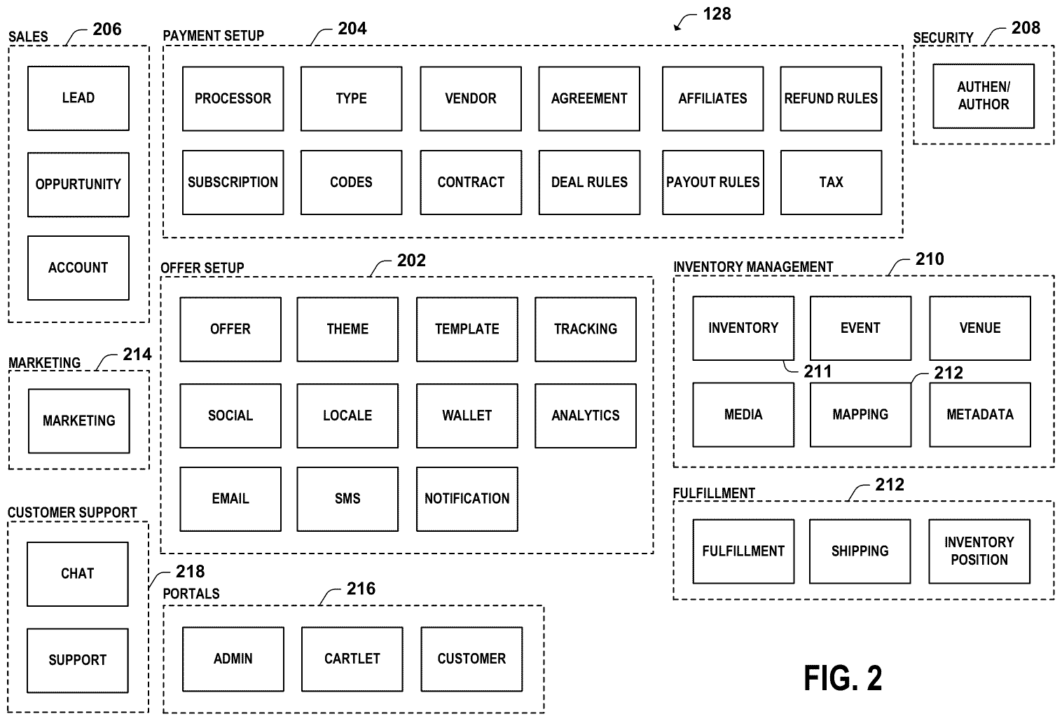

FIG. 2 illustrates examples of the bricks 128 used to define and construct the offer package 120. The bricks 128 are software structures that define the parameters, metadata, available inventory and/or audiovisual assets of the offer, the interrelationship between these parameters, metadata, available inventory and/or audiovisual assets, and the syntax of the data interchange format in which the package 120 is being created. The bricks 128 may have different versions representing different structures that may be selected depending on the desired structure of the offer package. When creating the offer package 120, the merchant may select the relevant bricks 128 to define the look and feel, the functionality, inventory management and grouping, and the order flow associated with the cart interface that is rendered using the offer package 120 constructed using the bricks 128 selected and populated by the merchant. The bricks 128 facilitate building the offer package 120 so to include the necessary parameters, metadata, available inventory and/or audiovisual assets of the offer and/or tokens point to the parameters and/or metadata to perform front end actions (e.g., the computing device 116 rendering the cart interface for the offer) and to perform backend actions (e.g., handle payment, refunds, fund allocation, customer service, etc.). In the illustrated example, the bricks 128 are arranged in thematic groups. However, the bricks 128 may be arranged in any manner. For example, when the packager 124 packages the selected bricks 128, into the offer package 120, the resulting structure of the offer package 120 mirrors the bricks 128. In some examples, the bricks 128 define interface elements that translate the structure of the bricks into interactable objects within an interface to design an offer. The interactable objects have inputs that facilitate receiving the information necessary to render the component of, for example, the cart interface and define relationships between the bricks 128. As such, as bricks 128 are added to an offer, a corresponding interface in an offer editor is generated.

In the illustrated example of FIG. 2, a group of bricks 128 is classified in an offer setup group 202. The bricks 128 in the offer setup group 202 are used to build the look and feel of the cart interface as well as the operation of the cart interface related to the specific offer. A group of bricks 128 is classified in a payment setup group 204. The bricks 128 in the payment setup group 204 are used to define rules for a transaction made of the specific offer and establish a transactional route and history for every good and/or service purchased through the offer. A group of bricks 128 is classified in a sale group 206. The bricks 128 in the sales group 206 interface with external customer management providers to connect offers to the merchant and facilitate merchant account management. The offer setup group 202, the payment setup group 204, and the sales group 206 contribute structure and metadata to the offer package 120 to facilitate forensically tracing and justifying any transaction that is made according to the offer package 120 and to supply a system with information to complete a transaction while minimizing the transaction's use of backend calls.

In the illustrated example, a group of bricks 128 is classified in a security group 208. Bricks 128 in the security group 208 provide parameters and metadata for performing the multiple security check to authenticate a customer and check if the customer is authorized to perform the transaction. A group of bricks 128 is classified in an inventory management group 210. Bricks 128 in the inventory management group 210 provide parameters and metadata for slicing and presenting inventory in the cart interface and interfacing with the inventory management system of the merchant. An inventory brick 211 provides a connector between the packager 124 and the IMS of the merchant 104 (sometimes referred to as an “adapter”). The inventory brick 211 includes, for example, specific API calls and limitations and/or parameters for those calls for the specific IMS of the merchant 104. In some examples, the packager 124 may include multiple inventory bricks 211 when multiple merchants 104 and/or multiple IMSs are involved in the offer. The inventory brick 211 retrieves or otherwise receives the inventory data object 125 from the IMS of the merchant 124. One of the parameters of the inventory brick 211, for example, may be the refresh interval specified by the IMS of the merchant 104 to limit the frequency the packager 124 may request the inventory data object 125. A mapping brick 212 receives the inventory data object 125 and facilitates the merchant 104 and/or the commerce platform 102 into slicing the inventory data object 125 into the inventory slices 127 to be included in the offer package 120 such that (a) the corresponding inventory is arranged/organized in the cart and/or checkout interface and (b) inventory has an appropriate quantity picker assigned in the cart and/or checkout interface, etc. A group of bricks 128 is classified in a fulfillment group 213. Bricks 128 in the fulfillment group 128 provide parameters and metadata for fulfilling and delivering inventory after a successful transaction. A group of bricks 128 is classified in a marketing group 214 to provide support to attributing sales of goods and/services to parties involved in completing the transaction (e.g., first party or third party sales agents, etc.). A group of bricks 128 is classified in a portals group 216. Bricks 128 in the portals group 216 provide top level structure to packages, including the offer package 120. A group of bricks 128 is classified in a customer support group 218 that includes structure, parameters, and metadata to render a customer support interface and to process customer support requests while minimizing the number of backend calls the customer's browser performs.

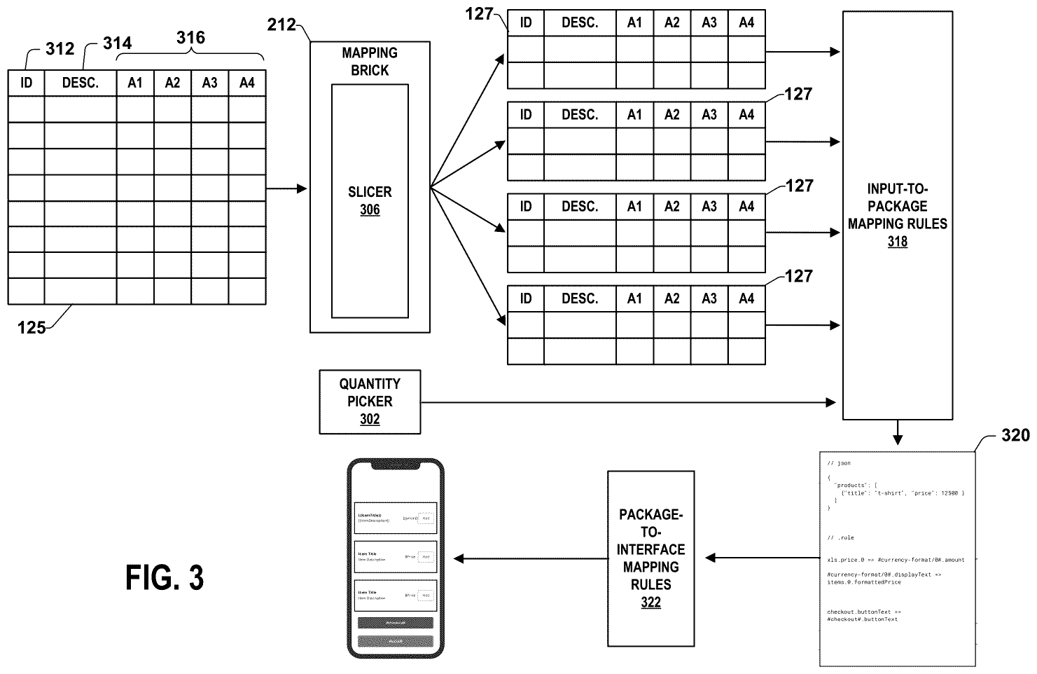

FIG. 3 is a conceptual diagram of the packager 124 of FIG. 1 generating the offer package 120. The packager 124 uses a plurality of bricks 128 to define the content of the offer package 120 and the structure of the offer package 124 that will be used to instantiate the cart and checkout interfaces using the resources of the computing devices 116 of the user accessing the corresponding offer instantiator 118. The merchant 102 interaction with the packager 124 through a packager interface that facilitates editing of the contents and structure of the offer package 120. The packager interface includes selectors to facilitate selection of which bricks 128 (e.g., and which subbricks, etc.) to use to generate the offer package 120 and edit the parameters and metadata associated with each of the selected bricks 128. These selectors may be graphical elements that are dragged and moved in the packager interface to select the bricks 128 and to define relationships between the bricks 128. For example, the bricks 128 may specify different widgets, different quantity pickers 302, different themes, different templates, define audio and/or visual assets to be used, and/or different ways to slice inventory, etc. (collectively referred to as “elements”). For example, the widgets define interactive interface elements in the cart interface that causes the hosting browser to perform an action that reaches externally from the browser (e.g., make a backend call, make a call to the payment processor 106, etc.). For example, one widget may define the parameters (e.g., size, shape, position, label, etc.) of the action button. As another example, one widget may define which third party payment processor to send information to facilitate instantiation of the payment processor's payment interface in the checkout interface.

In the illustrated example of FIG. 3, the mapping brick 212 includes a slicer 306. The slicer 306 facilitates transforming the inventory data object 125 of the inventory to be included in the offer package 120 into slices of inventory 127 that have common attributes and are to be organized in the cart interface together with and each associated with a quantity picker 302. The slices 127 may further be subdivided by the slicer 306 to form a hieratical set of sliced inventory, for example in a tree structure, where the bottom slices are assigned a quantity picker 302. The inventory data object 125 includes a unique identifier 312 for each inventory item or class of inventory item. For example, fungible items and/or services (e.g., such as clothing, consumables, etc.) may have an identifier that is associated with all items of the class (e.g., all shirts of the same cut, color, and size may have the same identifier, etc.), while pseudo-fungible and/or limited edition goods or services have unique identifiers. The inventory data object 125 includes a description 314 that provides a human-readable description of the goods and/or services. The inventory data object 125 includes attributes 316 that distinguish the goods in some way (e.g., descriptively (such as color, location, quality, etc.) and/or organizationally (such as discounts, relations, intangible quantifier, etc.). For example, the attributes may include a price, a group identifier, a color, a size, shape, one or more location related attributes, etc. The slicer 306 transforms the inventory data object 125 into the slices of inventory 127 based on the attributes 316 as designated via the mapping brick 212 by the merchant.

In the illustrated example of FIG. 3, the packager 124 includes input-to-package mapping rules 318 that transform the widgets (e.g., the quantity picker(s) 302), other elements (e.g., themes, templates, and/or audio and/or visual assets to be used, etc.), and, in the illustrated example, the inventory slices 127 into a data interchange formatted file 320 for the offer package 120. The mapping rules 308 map the sliced inventory 127 to quantity pickers 302, and other information defined by and through the bricks 128 (e.g., the widgets 304 and the elements 306, etc.), and translate the mapped sliced inventory 127 into syntax of the data interchange format such that all of the data required to build the cart interface and the checkout interface, all of the data to perform cart management functions (e.g., displaying inventory being offered, prices, and descriptions; manipulating quantities in the cart; estimating total price, etc.) are included in the offer package 120.

In the illustrated example, the data interchange formatted file 320 is process with package-to-interface rules 322 that specify how the elements will be graphically laid out by the cart interface and/or checkout interface based on, for example, the selected theme and template bricks and the target browser in which the interfaces will be created. For example, the package-to-interface rules 322 may define how the inventory slices 127 and the associated quantity pickers 302 are laid out on the available screen of the target browser taking into account space and processing limitations inherent in some computing devices, such as mobile devices. In some examples, the data interchange formatted file 320 may be processed by different sets for package-to-interface rules 322 to generate different versions of the offer package 120, where the offer initiator 120 causes the browser to download one of the versions of the offer package 120 based on the qualities of the browser. For example, a set of package-to-interface rules 320 may generate one offer package 120 for browsers operating on mobile devices (e.g., smart phones, smart watches, etc.), one offer package 120 for browsers operating on computing devices (e.g., desktop computers, tablets, laptop computers, etc.), and one offer package for browsers operating on mixed reality devices (e.g., virtual reality headsets, augmented reality headsets, etc.). That is, the package-to-interface rules 322 are configured to take into account limitations that are inherent in the computing device 116 that is operating the browser, such as limited screen area, existence of a touchscreen, processing power, and/or network bandwidth availability, etc. Because the input-to-package rules 318 are processed separately from the package-to-interface mapping rules 322, the rules sets 318 and 322 can be updated asynchronously. That is, the template bricks may be updated and the update will be implemented the next time the offer package 120 is published.

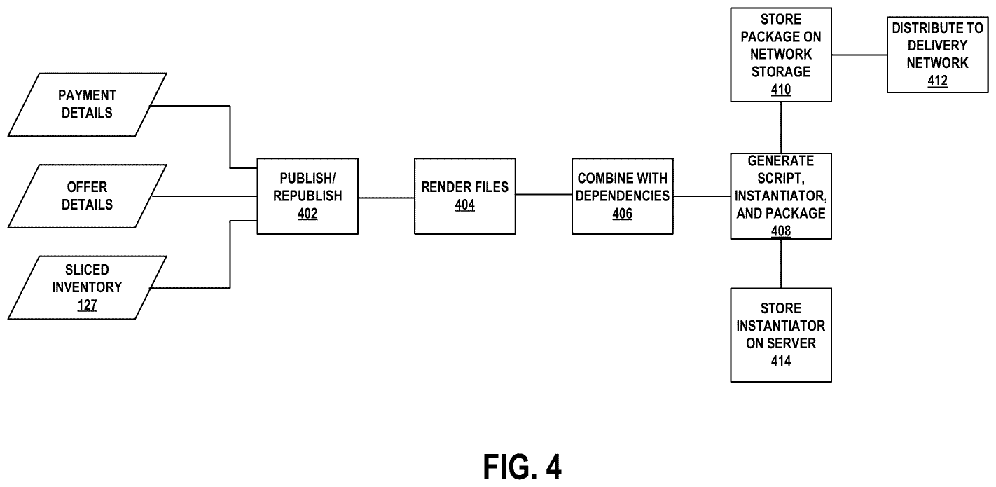

FIG. 4 is a conceptual diagram of the commerce platform 102 of FIG. 1 publishing the offer package 120 and the offer instantiator 118. The commerce platform 102 may asynchronously publish a republish of the offer instantiator 118 and the offer package 120 without regard to computing devices 116 instantiating the cart and/or checkout interface. At block 402, the entity using the commerce platform 102 (e.g., the merchant 104, etc.) indicates that the offer instantiator 118 and/or the offer package 120 should be published or republished. For example, a “publish” button may be provided in the packager interface. To start the process of publishing the offer instantiator 118 and the offer package 120, the packager 124 pulls in the template, the theme, the relevant metadata and parameters from the bricks and, in the illustrated example, the inventory slices 127. At block 404, the packager 124 renders the offer package 120. In some examples, the packager 124 renders the offer package 120 in accordance to the process described in connection with FIG. 3 above. The packager 124 may perform this rendering multiple times to generate offer packages 120 to be used by different browsers. At block 406, the packager 124 retrieves dependencies that are specified by the bricks 128 used to create the offer package 120. The dependencies may be, for example, libraries, audio and/or visual files (e.g., as designated by the selected template brick, the selected theme brick, and/or the selected quantity picker brick, etc.), and/or link paths (e.g., URLs, etc.), etc. Because bricks 128 can be updated asynchronously, decencies that may have changed since the last time the offer package 120 was published automatically have those dependencies updated in an offer package when it is republished. At block 408, the packager 124 generates the offer package(s) 120, the script used by the browser to generate the cart and checkout interfaces, and the offer instantiator 118 to be distributed. In some examples, the packager 124 may perform versioning of the offer package(s) 120 and the script each time the offer package(s) is/are republished. The offer instantiator 118 may be changed to point the browser to the updated script and/or updated offer package(s) 120 when the browser refreshes. At block 410, the packager 124 stores the script, the offer package(s) 120, and/or any assets necessary to render the cart interfaces to the network storage 110. To prevent network traffic, especially to a large number of applicable computing devices 116, the packager 124 does not notify any of the computing devices 116 operating browsers in which the cart and/or checkout interface is instantiated that the offer package 120 is being published/republished. At block 412, the package 124 causes the script, the offer package(s) 120, and/or the assets to be distributed to the networked storage 112 in the CDN 114. In some examples, the packager 124 sends a signal to the CDN 114 invalidating the current cache, which causes the network storage 112 in the CDN 114 to update to the latest files. At block 414, the offer instantiator 118 is moved the server(s) 108 to me accessed by the computing devices 116.

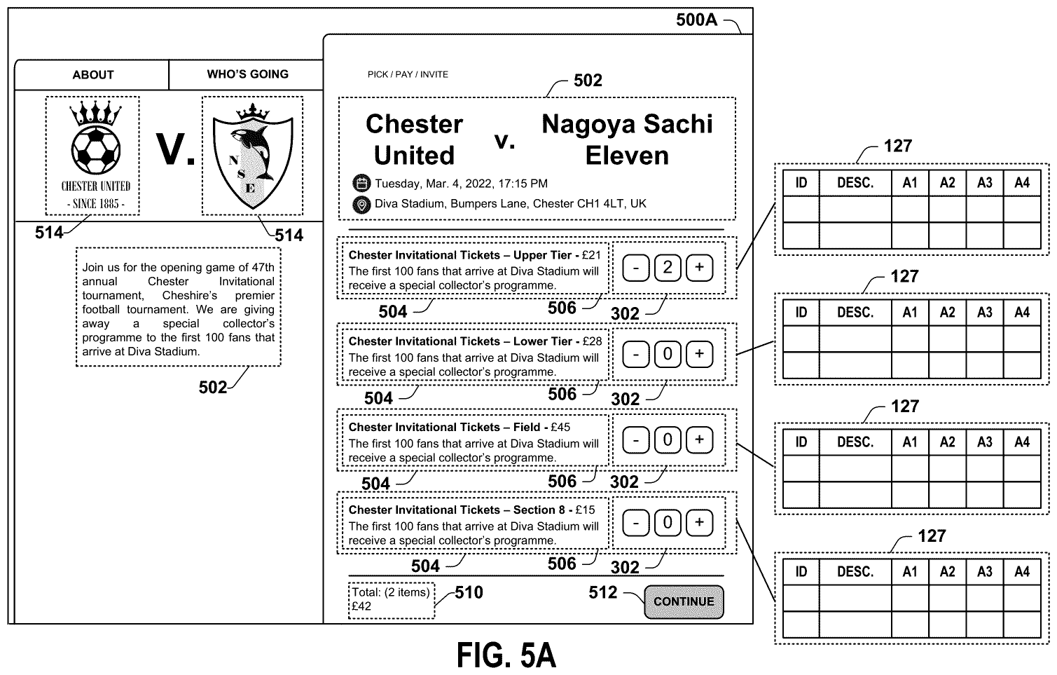

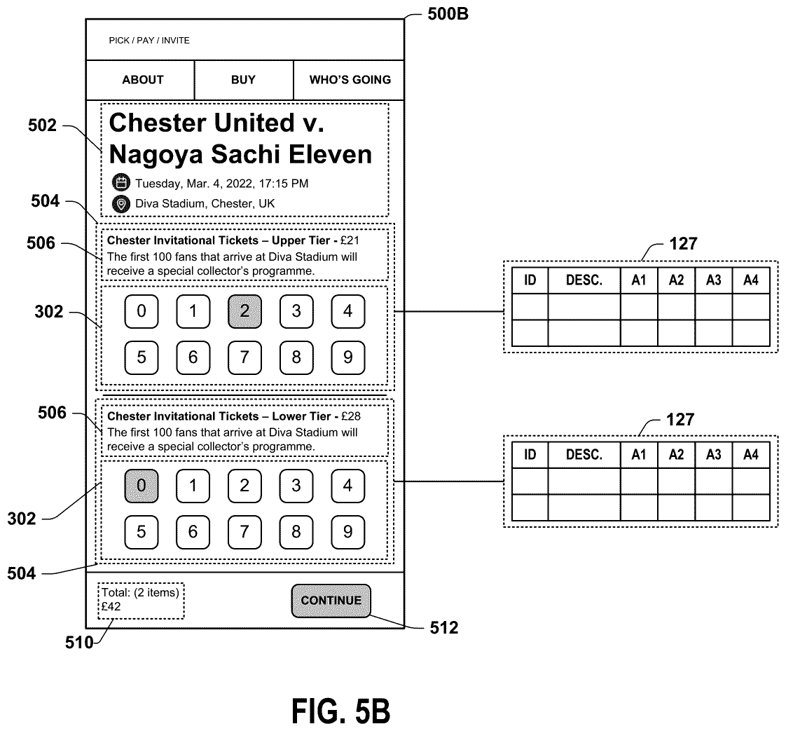

FIGS. 5A and 5B illustrate example cart interfaces 500A and 500B generated by a browser operating on a computer device 116 in response to being directed to the offer instantiator 118 based on the instantiating script and the offer package 120. In the illustrated example of FIG. 5A, the offer instantiator 118 causes the browser to fetch the instantiating script and offer package 120 to instantiate the cart interfaces 500A for a desktop browser. In the illustrated example of FIG. 5B, the offer instantiator 118 causes the browser to fetch the instantiating script and offer package 120 to instantiate the cart interfaces 500B for a mobile browser. In the illustrated examples of FIGS. 5A and 5B, the cart interfaces 500A and 500B have the same elements 502, 504, 506, 510, 512, and 514 that are rearranged and contextualized, by the script and/or the contents of the offer package 120 to use the browser resources available (such as screen space, input method, processing power, bandwidth availability, etc.). For example, the elements 502, 504, 506, 510, 512, and 514 of the cart interface 500B of FIG. 5B are differently arranged compared to the elements 502, 504, 506, 510, 512, and 514 of the cart interface of FIG. 5A to present the same information in a manner that takes into account the limited space on which to display an interface on a mobile device. Once the offer package 120 are loaded in a browser, the instantiating script generates the code and makes the necessary calls to instantiate the cart interface 500 and perform cart management functions without making a backend call. In the illustrated examples of FIGS. 5A and 5B, the quantity picker 302 is different between the cart interface 500A instantiated on the desktop browser compared to the quantity picker 302 of the cart interface 500B instantiated on the mobile browser. From time-to-time, the commerce platform 102 may asynchronously update the offer package 120 and/or the instantiating script. In response to regenerating the offer package 120 and/or the instantiating script, the commerce platform 102 does not generate a signal to the browser to instruct the browser to refresh. The browser updates the cart interface 500A and 500B in response to an event that causes the browser to re-fetch the offer package 120 and/or the script (e.g., the user instructing the browser to refresh, the commerce platform 102 sending a refresh instruction in response to the user's actions, etc.).

As described in FIGS. 3 and 4 above, the office package 120 includes the inventory slices 127 in the offer package 127 and structures the inventory slices 127 such that the elements of the inventory data objects 125 are have corresponding elements 302, 504, and 506 in the cart interface 500A and 500B. In the illustrated examples, the cart interface 500A and 500B includes a high level description 502 of the inventory and an inventory item 504 for each inventory slice 127 in the offer package 127 The high level description 502 provide details that are generally applicable to all of the inventory items 504 (e.g., a title for the offer, a date, time and/or location relevant to the offer, etc.). In the illustrated example, each of the inventory items 504 corresponds to one of the inventory slices 127. While for illustrative purposes, only a limited number of inventory items 504 are shown, the cart interface 500 may include as many inventory items 504 as the inventory slices 127 that are defined in the offer package 120. The inventory item 504 includes a description 506 of the inventory being offered corresponding to the description 314 and/or the attributes 316 from the inventory data object 125.

In the illustrated example, the inventory slices 127 define a set of pseudo-fungible goods that, for the purposes of the cart interface 500A and 500B, are interchangeable. The example inventory slices 127 include multiple rows from the inventory data object 125 (sometimes referred to a “pool of inventory”), each row representing a unique good or service (e.g., a ticket for a particular seat in a venue, a particular non-fungible token, a particular limited edition item, etc.) that has one or more attributes 316 in common (such as, price, region of the venue, target consumer, etc.). As such, each inventory item 504 represents one of these pools of inventory. As the offer package 120 is updated with changes to the inventory slices 127, the script may cause the browser to instantiate more or fewer inventory objects 504 based on the updated inventory slices 127 in the updated offer package 120.

Each of the inventory items 504 is associated with a quantity picker 302 as defined in the offer package 120. When the quantity of items in the quantity picker 302 is changed, the browser, without making a backend call, estimates the total amount based on the information in the offer package 120 and displays the estimated total in a total field 510. Because this calculation is done entirely within the browser: (a) the calculation is quick, and (b) the manipulating of the inventory in the cart interface 500A and 500B does not result in traffic being directed to the commerce platform 102 and does not result in any queries into the IMS of the merchant 104. Using the script 121, based on the offer package 120, this cart management is repeated until the customer interacts with the action button 512. In this manner, the customer may browse the inventory items 504 and adding items to the cart without any traffic being directed at the commerce platform 102.

The look and feel of the cart interface 500A and 500B is dictated by the selected template brick and the selected theme brick. The template brick dictates how the script 121, in conjunction with the offer package 120, generates code to define the layout of elements 502, 504, 506, 302 510, 512, and 514 within the cart interface 500A and 500B. If, during block 402 of FIG. 4, the merchant were to select a different template brick or the template brick definition changed (e.g., changes that would take effect in block 406 of FIG. 4), when the customer refreshes the browser, the script 121, in conjunction with the offer package 120 would generate a changed layout. The selected theme brick dictates the aesthetic look and feel (e.g., color, audio visual assets 512, etc.). If, during block 402 of FIG. 4, the merchant were to select a different theme brick or the theme brick definition changed (e.g., changes that would take effect in block 406 of FIG. 4), when the customer refreshes the browser, the script 121, in conjunction with the offer package 120 would generate a different look and feel of the cart interface 500.

The cart interface 500A and 500B is different from the checkout interface. The cart interface 500A and 500B does not, until the action button 512 is interacted with, provide a method for the browser, during the course of the user browsing the inventory, to perform backend calls. Thus, in the cart interface 500A and 500B, selecting and deselecting inventory (e.g., via the quantity picker 302) does not result in network traffic directed towards the commerce platform 102. Additionally, in some examples, actually purchasing the selected inventory cannot be accomplished through the cart interface 500A and 500B (e.g., purchasing is gated by proceeding to the checkout interface, etc.) As a result, a large number of users can simultaneously interact with a cart interface 500A and 500B instantiated entirely in their own browser without causing any network traffic to be directed towards the commerce platform 102. The checkout interface facilitates the browser receiving a calculation of actual cost of the selected inventory (via low processing-load backend calls to the commerce platform 102) and initiating purchase of the inventory (via interaction with a checkout button). Until an actual purchase of inventory is initiated (e.g., the user interacting with the checkout button), the checkout interface does not cause any queries into the IMS database 132.

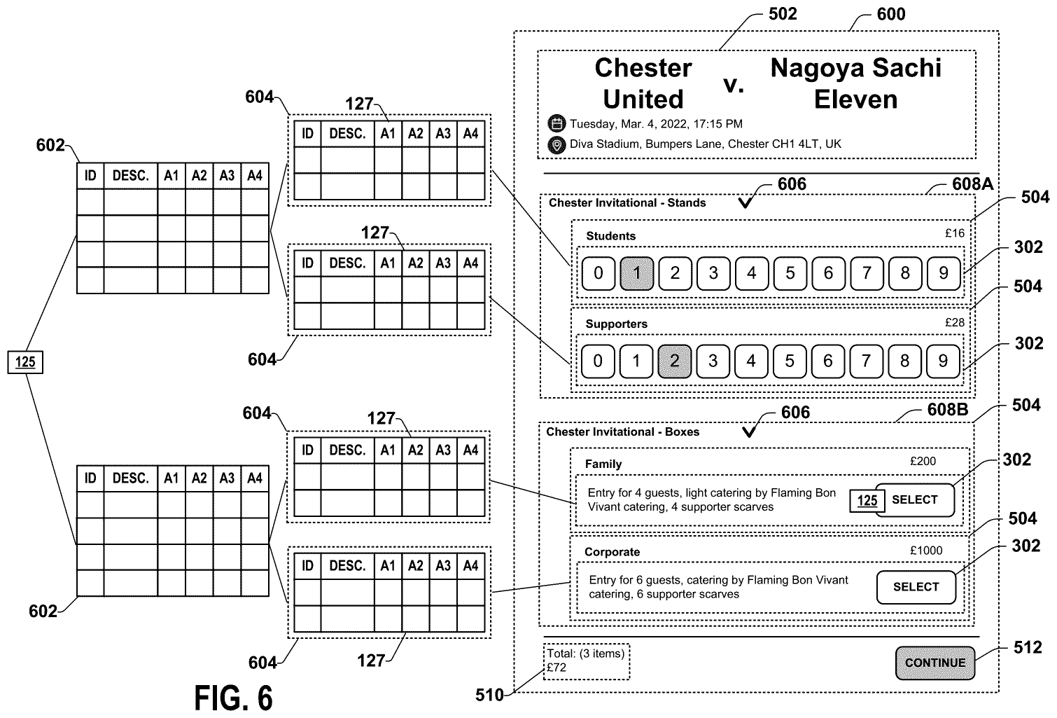

FIG. 6 illustrates an example chart interface 600 where the inventory data object 125 is defined to have a hierarchical structure. In the illustrated example, the inventory data object 125 is defined to have a first tier 602 (sometime referred to as a “variant”) and a second tier 604 (sometimes referred to as a “sub-variant”). While two tiers are illustrated in FIG. 6, the inventory data object 125 may be sliced to have more than two tiers. In the illustrated example, the first tier 602 represents the rows of the data object that have at least at least one attribute 316 in common, and the second tiers 604 that share the same first tier 604 have at least one attribute 316 not in common such to create distinguishable, but related, pools of inventory. In the illustrated example, the first tier 602 has two second tiers 602; however, first tier 602 may have more than two second tiers 602. Additionally, the first tiers 602 in the offer package 120 do not have to have the same number of second tiers 604 and the first tiers 602 may have to terminate at the same depth (e.g., sub-variants may themselves be sliced to have sub-variants, etc.). The deepest tier in each of the branches that define the hierarchy of the inventory data object 125 are the inventory slices 127 that are instantiated in the cart interface 600 as the inventory objects 504 and are associated with inventory pickers 302.

In the illustrated example, the instantiating script, based on the offer package 120, instantiates the cart interface 600 with the inventory items 504 displayed in a nested structure that corresponds to the hierarchy defined for the inventory data object 125. As illustrated in FIG. 6, goods may be initially displayed as a list of categories of goods that, when an interface element 606 is clicked, reveal the individual available inventory items 504 corresponding to the inventory slices 127 that are defined to be in that level of the hierarchy. For example, for event tickets, the cart interface 600 may initially display a label next to the interface element 606 for sections of seats within the venue (where a “section attribute” is the attribute 316 that each row of the inventory data object 125 sliced into the first tiers 602 has in common). In such an example, when the interface element 606 is interacted with, the cart interface 600 displays the inventory items 504 associated with each second tier 604 of the corresponding first tier 602, where each inventory item 504 represents a separate row within that section of the venue (where a “row attribute” is the attribute 316 that the rows of the inventory data object 125 in the respective second tiers 604 do not have in common).

In the illustrated example of FIG. 6, the inventory item 504 are grouped in a first level 608A and 608B corresponding to the first tiers 602 of the hierarchical tree. The inventory items 504 correspond with the second tiers 604 of the hierarchical tree. In the illustrated examples, the inventory items 504 in each of the first levels 604A and 604B are associated with a different type of the quantity picker 302 because, for example, the characteristics of the inventory items 504 is in each of the first levels 604A and 604B are different. All of the information necessary to construct the cart interface 600A and 600B with the inventory items 504 organized in such a heretical manner is included in the offer package 120 such that instantiating the cart interface 600A and 600B does not require a backend call.

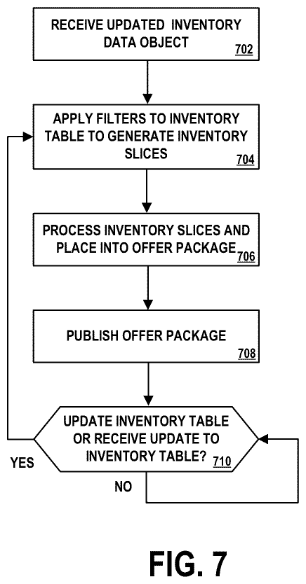

FIG. 7 illustrates an example method to update inventory in a cart interface (e.g., the cart interfaces 500A, 500B, and 600 of FIGS. 5A, 5B, and 6) of a network traffic surge resistant platform 102 without generating traffic between the platform 102 and the computing devices 116 hosting the cart interfaces. The platform 102 receives an updated inventory data object 125 (block 702). In some examples, the platform 102 may receive or otherwise retrieve the inventory data object 125 from the IMS of the merchant 104. Alternatively or additionally, in some examples, the platform 102 may maintain internal copy of the inventory data object 125 that is updated as customers order and is verified by a relatively less frequent update to the inventory data object 125 by the IMS of the merchant 104. The packager 124 then applies the filters specified by the slicer 306 to the updated inventory data object 125 to generate the updated inventory slices 127 (block 704). The packager 124 processes the updated inventory slices 127 and places them in an updated offer package 120 (e.g., as described in connection with FIGS. 3 and 4 above) (block 706). The platform 102 then published the offer package 120 containing the updated inventory slices 127 to the network storage 110 and 112. (708). The platform 102 waits until an updated inventory data object 125 is received (block 710). When the platform 102 receives an updated inventory data object 125 (YES at block 710), applies the filters specified by the slicer 306 to the updated inventory data object 125 to generate the updated inventory slices 127 (block 704).

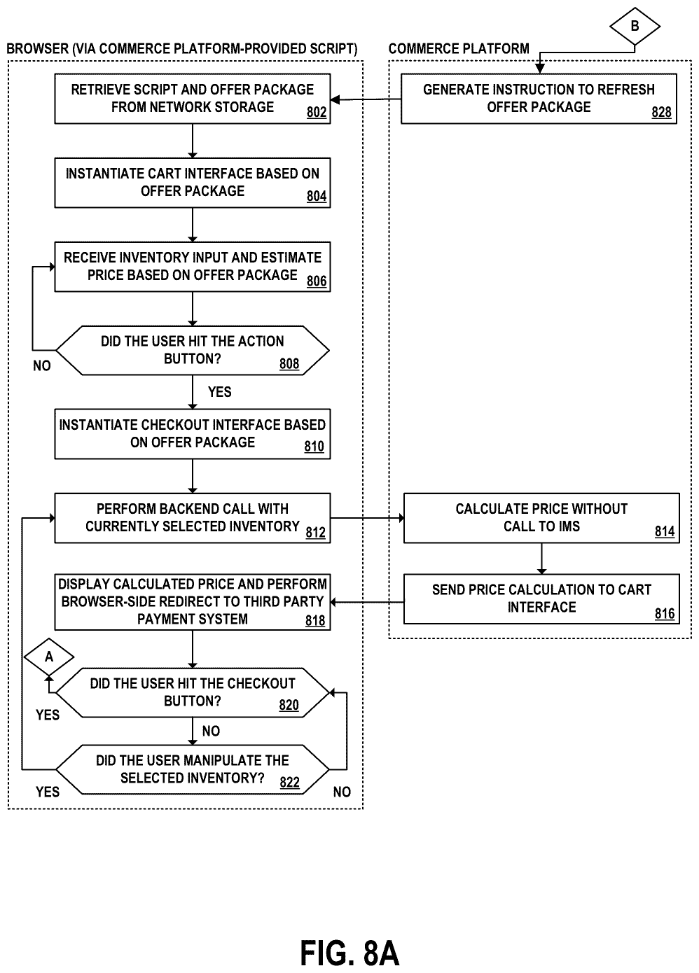

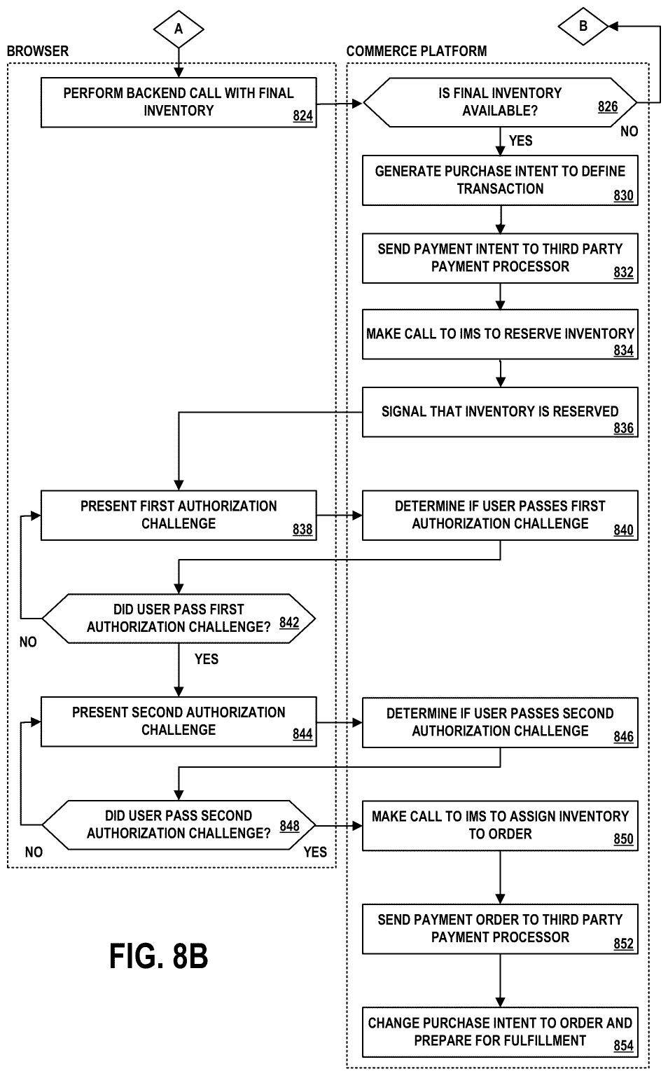

FIGS. 8A and 8B illustrate an example method to provide for a network traffic surge resistant platform. The method begins when a user loads the offer instantiator 118 into a browser. For example, the user may click on a URL that directs the browser to the offer instantiator 118. Generally, the method minimizes traffic generated towards the commerce platform 102 and queries into the IMS database 132 until the user has demonstrated that greater network traffic and database resource allocation is appropriate. Interface generation (e.g., the cart interfaces 500A and 500B of FIGS. 5A and 5B, the cart interface 600 of FIG. 6, etc.) and initial cart management is performed by the browser using the processing and memory power of the computing device 116.

Initially, the browser, based on the instructions provided by the offer instantiator 118, retrieves the script and offer package 120 from the network storage 112 in the CDN 114 (block 802). The distributive nature of the network storage 112 in the CDN 114, coupled to the relatively low processing and network intense activity of retrieving the script and offer package 120, means that a network traffic surge is not directed at the commerce platform 102 even when a large number of users load the offer instantiator 118 into their browser. The browser, executing the script, instantiates the cart interface in the browser based on the offer package 120 without making any backend calls to the commerce platform 102 (block 804). The browser receives inventory input (e.g., by manipulation of the quantity picker 508, etc.) and estimates the price of the selected inventory based on the offer package 120 without making any backend calls that result in queries to the IMS (block 806). The estimated price may be displayed in the total field 510 of the cart interface 500A. The browser waits until it receives an inventory input or the user interacts with the action button 512 (block 808). When the browser receives an inventory input (“NO” at block 808), the browser estimates the price of the selected inventory based on the offer package 120 without making any backend calls that result in queries to the IMS (block 806).

When the browser detects that the user interacts with the action button 512 (“YES” at block 808), the browser, using the script, instantiates the checkout interface based on the offer package 120 (block 810). The user may return to the cart interface (e.g., return to block 804) at any point. The browser, based on the script, performs a backend call to the commerce platform 102 that includes the currently selected inventory of the cart interface (block 812).

The commerce platform 102, in response to receiving the backend call, calculates a price for the currently selected inventory based on the offer package 120 without generating a query to the IMS of the merchant 104 (block 814). The offer package 120 may include obscured and/or encrypted data that commerce platform 102 is able to unobscured and/or decrypt related to costs beyond the price of the inventory. For example, the commerce platform 102 may calculate the price of the inventory, any fees specified/allowed by the contract with the merchant 104, and/or taxes to be levied on the purchase. This is a relatively low processing cost calculation. The commerce platform 102 returns the calculated price to the browser that issued the backend call (block 816). In some examples, the commerce platform 102 may, on copy of the inventory data object 125, track the inventory positions as orders are placed. In such examples, the commerce platform 102 may check to determine whether the goods and/or services indicated by the backend call are available without making a call to the IMS. When the goods and services are not available, the commerce platform 102 may, instead of sending calculated price to the browser, send an instruction to cause the browser to refresh and retrieve the offer package 120 to cause the browser to update the cart interface.

The browser, using the script, displays the calculated price in the checkout interface and performs a browser-side redirect (sometimes referred to as a “client-side redirect”) to the third party payment processor(s) 106 to provide the calculated price (block 818). This allows one or more payment interfaces of the third party payment processor(s) 106 to instantiate within the checkout interface and facilitate payment for the selected inventory. This browser-side redirect means that the resources of the browser, not the commerce platform 102, are used to provide the information necessary for the payment interface(s) to instantiate. Thus, if the user does not proceed with checking out, the network resources used by the user towards the commerce platform 102 have been minimal and no IMS database 132 resources have been expended because of the user.

The browser, using the script, determines whether the user interacts with the checkout button (block 820). When the user does not interact with the checkout button (“NO” at block 820), the browser, using the script, determines whether the user manipulated the selected inventory in the checkout interface (block 822). When the user manipulates the selected inventory (“YES” at block 822), the browser, based on the script, performs a backend call to the commerce platform 102 that includes the currently selected inventory of the cart interface (block 812). When the user does not manipulate the selected inventory (“NO” at block 822), the browser determines whether the user interacts with the checkout button (block 820). When the user interacts with the checkout button (“YES” at block 820), the browser, using the script, performs a backend call that includes the selected inventory (block 824 of FIG. 8B).

The commerce platform 102 determines whether the selected inventory in the backend call is available to be reserved, by for example, checking the version of the inventory data object 125 being maintained by the commerce platform 102 (block 826). The selected inventory may already have been reserved during a different transaction, for example, because of the large amount of simultaneous users. When the selected inventory is not available (“NO” at block 826), the commerce platform 102 generates an instruction to cause the browser to retrieve the offer package 120 that contains updated inventory slices 127 (block 828 on FIG. 8A). Otherwise, when the selected inventory is available (“YES” at block 826), the commerce platform 102 generates a purchase intent to define the transactions (block 830). The purchase intent is a record of an offer identifier, a browser identifier, an order identifier, a price, and inventory to be purchased, etc. that facilitates tracking an order beginning from the offer instantiator 118 and the offer package 120 to the checkout process such that any transaction can be audited. The purchase intent is linked to the information necessary to verify the content of the transaction.

The commerce platform 102 sends a payment intent to the third party payment processor 106 (block 832). The payment intent may cause the third party payment processor 106 to collect payment information from the user (e.g., via the payment processor widget, etc.) and/or place a hold on funds sufficient to pay the calculated cost. The commerce platform 102 then makes a call to the IMS of the merchant 104 to place a reserve on the selected inventory (block 834). The reserve temporary prevents the entries in the inventory database 132 representative of the inventory from being reserved or otherwise purchased. The commerce platform 102 then signals to the browser that the inventory is reserved (block 836).

The browser, using the script, presents a first authorization challenge (block 838). In some examples, the authorization challenges may be credentials that the user enters where at least one piece of information for the user to enter is a secret (e.g., a user specified password or passcode, an mobile application-based one-time passcode (e.g., a HMAC-based One-time Password algorithm (HOTP) code, a Time-based One-time Password Algorithm (TOTP) code, etc.), a SMS or email-based one-time password (OTP) code, a code provided by a USB or embedded chip based key (sometimes referred to as a “smartcard” or a “security token”), etc.). Upon entry of the answer to the first authorization challenge, via the script, the browser forwards the entry to the commerce platform 102 to determine if the user passes the first authorization challenge.

The commerce platform 102 determines whether the entry provided by the user passes the first authorization challenge and forwards this determination to the browser (block 840). For example, the user may fail the first authorization challenge by entering a mismatched set of credentials, by entering the wrong OTP, and/or waiting too long to enter the OTP. For example, the user may pass the first authorization challenge by entering a matching set of credentials and/or by entering the correct OTP associated with the identifier.

The browser, using the script, determines whether the user passed the first authorization challenge (block 842). When the user does not pass the first authorization challenge (“NO” at block 842), the browser presents a first authorization challenge again (block 844). In some examples, the browser, using the script, may limit the number of times the first authorization challenge may be attempted before, for example, transmitting a message to the commerce platform 102 to end the transaction (e.g., revoking the payment invent and unreserving the inventory, etc.). When the user does passes the first authorization challenge (“YES” at block 842), the browser, using the script, presents a second authorization challenge (block 844). The second authorization challenge requires entry of different secret information than the first authorization challenge that has a different origin than the secret information of the first authorization challenge. For example, the first authorization challenge may be entry of an OTP received from a SMS message and the second authorization challenge may be entry of a different OTP receive from an email. In some examples, the authorization challenges may be structured such that they may be performed without the user having an account or prior relationship with the commerce platform 102. In some examples, the first authorization challenge may require entry on a mobile phone number to which the commerce platform 102 sends a first OTP and the second authorization challenge may require entry of an email address to which the commerce platform 102 sends a second OTP. In such examples, these credentials (e.g., the mobile number and email address) may be associated with the purchase intent such that future fulfillment requires entry of the same mobile number-email address pair (e.g., in response to subsequent authorization challenges at the time of fulfillment, etc.). Although two authorization challenges are described wherein, there may be fewer (e.g., one) or more (e.g., three or more) authorization challenges. Upon entry of the answer to the second authorization challenge, via the script, the browser forwards the entry to the commerce platform 102 to determine if the user passes the second authorization challenge.

The commerce platform 102 determines whether the entry provided by the user passes the second authorization challenge and forwards this determination to the browser (block 844). For example, the user may fail the second authorization challenge by entering a mismatched set of credentials, by entering the wrong OTP, and/or waiting too long to enter the OTP. For example, the user may pass the second authorization challenge by entering a matching set of credentials and/or by entering the correct OTP associated with the identifier.

The browser, using the script, determines whether the user passed the second authorization challenge (block 848). When the user does not pass the second authorization challenge (“NO” at block 848), the browser presents a second authorization challenge again (block 844). In some examples, the browser, using the script, may limit the number of times the second authorization challenge may be attempted before, for example, transmitting a message to the commerce platform 102 to end the transaction (e.g., revoking the payment invent and unreserving the inventory, etc.).

When the user passes the second authorization challenge (“YES” at block 848), the commerce platform 102 makes a call to the IMS of the merchant 104 to the selected inventory to be fulfilled (block 850). The commerce platform 102 sends a payment order to the third party payment processor (block 852). The payment order causes the third party payment processor based on the payment intent. The commerce platform changes the purchase intent to a purchase order and prepares for fulfillment (e.g., perform post fulfillment tasks, such as gathering shipping information, etc.) (block 854).

Although the embodiments of the present invention have been illustrated in the accompanying drawings and described in the foregoing detailed description, it is to be understood that the present disclosure is not to be limited to just the embodiments disclosed, but that the disclosure described herein is capable of numerous rearrangements, modifications and substitutions without departing from the scope of the claims hereafter. The terms “includes,” “including,” and “include” are inclusive and have the same scope as “comprises,” “comprising,” and “comprise” respectively. The claims as follows are intended to include all modifications and alterations insofar as they come within the scope of the claims or the equivalent thereof

Having thus described the invention, the following is claimed:

1. A network traffic surge resistant system comprising:
network storage; and
one or more servers configured as a commerce platform configured to:
at a first time, generate a script, a first offer package, and an offer instantiator, and store the script and the first offer package onto the network storage, the offer instantiator providing the location of the script and the first offer package in the network storage, and the first offer package including a first set of inventory slices; and
at a second time after the first time:
generate a second set of inventory slices, wherein generating second set of inventory slices does not cause the commerce platform to generate an update signal to any browsers, and
generate a second offer package that includes the second set of inventory slices and replace the first offer package with the second offer package in the same location in the network storage;
wherein, in response to a browser operating on a computing device accessing the offer instantiator after the first time but before the second time:
causing, by the offer instantiator, the browser to retrieve the script and the first offer package from the network storage;
causing, by the script, the browser to instantiate a cart interface within the browser based on the first offer package using the resources of the computing device without making a backend call to the commerce platform, the cart interface including a first set of inventory items based on the first set of inventory slices; and
wherein, in response to the browser accessing the offer instantiator after the second time:
causing, by the offer instantiator, the browser to retrieve the second offer package from the network storage; and
causing, by the script, the browser to instantiate the cart interface within the browser based on the second offer package using the resources of the computing device without making a backend call to the commerce platform, the cart interface including a second set of inventory items based on the second set of inventory slices.

2. The system of claim 1, wherein before the first time, the commerce platform receives an inventory data object and, wherein the commerce platform is configured to apply a filter to the inventory data object to generate the first set of inventory slices.

3. The system of claim 2, wherein before the second time, the commerce platform receives an updated version of the inventory data object, and wherein the commerce platform is configured to apply the filter to the updated version of the inventory data object to generate the second set of inventory slices.

4. The system of claim 2, wherein receiving an updated version of the inventory data object triggers, at the second time, generating a second offer package.

6. The system of claim 1, wherein the first offer package defines an interface element for each of the inventory slices in the first set of inventory slices to facilitate a user changing the quantity of a good or service currently present in the checkout interface.

7. The system of claim 1, wherein the first set of inventory slices define a first tier and a second tier, the first offer package defining an interface element for each of the inventory slices in the second tier to facilitate a user changing the quantity of a good or service currently present in the checkout interface

8. The system of claim 1, wherein the first and second sets of inventory slices define a list of goods or services to be made available via the cart interface such that browsing the goods and services in the cart interface does not cause the browser to make a backend call to the commerce platform.

9. The system of claim 1, wherein the script causes the browser to instantiate the cart interface with an action button, and wherein, in response to receiving a backend call caused by activation of the action button, the commerce platform is to instruct the browser to refresh when an item designated in the backend call does not appear in an updated version of the inventory data object maintained by the commerce platform.

10. The system of claim 1, wherein to cause the browser to instantiate the cart interface, the script generates instructions, using the resources of the computing device, for the browser to execute based on the first or second offer package.

11. A method for asynchronously updating a cart interface for a network traffic surge resistant platform, the method comprising:
at a first time, (i) generating, by the network traffic surge resistant platform, a script, a first offer package, and an offer instantiator, and (ii) storing the script and the first offer package onto the network storage, the offer instantiator providing the location of the script and the first offer package in the network storage, and the first offer package including a first set of inventory slices; and
at a second time after the first time, (i) generating, by network traffic surge resistant platform, a second set of inventory slices, wherein generating second set of inventory slices does not cause the commerce platform to generate an update signal to any browsers, and (ii) generating a second offer package that includes the second set of inventory slices and replace the first offer package with the second offer package in the same location in the network storage;
wherein, in response to a browser operating on a computing device accessing the offer instantiator after the first time but before the second time:
causing, by the offer instantiator, the browser to retrieve the script and the first offer package from the network storage;
causing, by the script, the browser to instantiate a cart interface within the browser based on the first offer package using the resources of the computing device without making a backend call to the commerce platform, the cart interface including a first set of inventory items based on the first set of inventory slices; and
wherein, in response to the browser accessing the offer instantiator after the second time:
causing, by the offer instantiator, the browser to retrieve the second offer package from the network storage; and
causing, by the script, the browser to instantiate the cart interface within the browser based on the second offer package using the resources of the computing device without making a backend call to the commerce platform, the cart interface including a second set of inventory items based on the second set of inventory slices.

12. The method of claim 11, further comprising:
before the first time, receiving, by the network traffic surge resistant platform, an inventory data object; and
applying, by the network traffic surge resistant platform, a filter to the inventory data object to generate the first set of inventory slices.

13. The method of claim 12, further comprising
before the second time, receiving, by the network traffic surge resistant platform, an updated version of the inventory data object; and
applying, by the network traffic surge resistant platform, the filter to the updated version of the inventory data object to generate the second set of inventory slices.

14. The method of claim 12, wherein receiving an updated version of the inventory data object triggers, at the second time, generating a second offer package.

16. The method of claim 11, wherein the first offer package defines an interface element for each of the inventory slices in the first set of inventory slices to facilitate a user changing the quantity of a good or service currently present in the checkout interface.

17. The method of claim 11, wherein the first set of inventory slices define a first tier and a second tier, the first offer package defining an interface element for each of the inventory slices in the second tier to facilitate a user changing the quantity of a good or service currently present in the checkout interface

18. The method of claim 11, wherein the first and second sets of inventory slices define a list of goods or services to be made available via the cart interface such that browsing the goods and services in the cart interface does not cause the browser to make a backend call to the commerce platform.

19. The method of claim 11, further comprising causing, by the script, the browser to instantiate the cart interface with an action button, and wherein, in response to receiving a backend call caused by activation of the action button, the commerce platform is to instruct the browser to refresh when an item designated in the backend call does not appear in an updated version of the inventory data object maintained by the commerce platform.

20. The method of claim 11, wherein to cause the browser to instantiate the cart interface, the method further comprise generating, by the script, instructions, using the resources of the computing device, for the browser to execute based on the first or second offer package.
